(19) United States
(12) Patent Application Publication
(10) Pub. No.: US 2011/0186558 A1
(43) Pub. Date: Aug. 4, 2011

(54) HEATING DEVICE HAVING HANGING PORTION

(76) Inventor: Stephanie Campbell, Bel Air, MD (US)

(21) Appl. No.: 13/004,445

(22) Filed: Jan. 11, 2011

Related U.S. Application Data
(60) Provisional application No. 61/337,334, filed on Feb. 3, 2010.

(51) Int. Cl. H05B 1/00

(52) U.S. Cl. 219/201

(57) ABSTRACT

A device is provided that includes an enclosure, a heating element and a hanging portion. The enclosure has a first end and a top surface. The heating element is disposed within the enclosure. The hanging portion is connected to the first end and can hang the enclosure in a direction that is normal to the top surface.

The present application claims priority from U.S. Provisional Application No. 61/337,334 filed Feb. 3, 2010, the entire disclosure of which is incorporated herein by reference.

### BACKGROUND

The present invention relates generally to flexible electric warming pads.

One form of flexible electric warming pad is used for bed warming and typically includes a heating element that extends through the warmer and through which electric current passes to generate heat. These bed warming devices are typically applied to the top of the mattress pad for semi permanent use, applied along with the sheets or blankets as a heated covering, or inserted temporarily into the sleeping space prior to the occupant's arrival into the bed. In either of the first two cases, the design of the warming pad is limited to a construction that is both safe and comfortable for the occupant during its use.

Electromagnetic field effects should be considered relative to their long term effect on the human physiology, and construction materials should be chosen that provide a smooth and flexible form that doesn't disrupt the occupants sleep and is not degraded by constant bending, folding and flexing. Additionally for the first two cases, the regulation and control of temperature is quite important since the bed occupant is directly exposed for an extended time to the heat generated by the warming device.

In the case of the temporary bed warmer which is inserted into the occupants sleeping space prior to sleep, the prior art devices have typically made use of hot air blowers and distribution tubes, rigid box shaped enclosures with resistive heating elements, or heavy gel or fluid filled containers; all of which present an insertion and handling challenge to the user during use, and a storage challenge to the user when not in use.

Another potential application for flexible warming pads is for pre-heating heavy over-garments such as coats and jackets. These heavy garments can have a significant thermal mass or heat capacitance that tends to cool the body when the wearer first puts them on, particularly if the garment is damp from previous use. Short of encapsulating the entire garment in a heated environmental enclosure, prior art solutions have not recognized the applicability of flexible warming pads for this opportunity.

What is needed is a heating device that is flexible and can be easily stored.

### BRIEF SUMMARY

The present invention provides a heating device that is flexible and that can be easily stored.

In accordance with an aspect of the present invention, a device includes an enclosure, a heating element and a hanging portion. The enclosure has a first end and a top surface. The heating element is disposed within the enclosure. The hanging portion is connected to the first end and can hang the enclosure in a direction that is normal to the top surface.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a top plan view of a flexible warming pad according to an embodiment of the present invention;

FIG. 2A illustrates a top plan view of the flexible warming pad partially in section, with a portion of the outer cover removed to show the components inside;

FIG. 2B illustrates an enlarged cross sectional view of the flexible warming pad taken along line I-I of FIG. 1;

FIG. 2C illustrates an enlarged cross sectional view of the flexible warming pad taken along line II-II of FIG. 1;

FIG. 3 illustrates a schematic electrical circuit diagram of a series parallel assembly of resistive heating elements;

FIG. 4 illustrates a fragmentary top plan view of the flexible warming pad partially in section with a portion of the top covering removed to show the integral timer switch and frame structure inside;

FIG. 5 illustrates a fragmentary top plan view of the flexible warming pad partially in section with a portion of the top covering removed to show the internal components within the warming pad and also showing a detachable timer based power control system;

FIG. 6 illustrates an enlarged fragmentary top plan view of the flexible warming pad illustrated in FIG. 4, with the top covering removed to show more details of the integral timer switch and frame structure;

FIG. 7 illustrates a side elevation view of a flexible warming pad in a storage closet where a portion of the closet wall, door, rail, and floor are sectioned to show the clearance between the internal closet walls and the edges of the flexible warming pad;

FIGS. 8A-I illustrate fragmentary top plan views for various embodiments of a flexible warming pad, the various embodiments showing different attachment methods for joining a detachable storage hook to the flexible warming pad; wherein: FIG. 8A illustrates buttons and loops or button holes; FIG. 8B illustrates fabric snaps; FIG. 8C illustrates hook and loop flexible fastener; FIG. 8D illustrates magnet to magnet or magnet to steel couplers; FIG. 8E illustrates individual hooks and mating holes; FIG. 8F illustrates male and female dovetails; FIG. 8G illustrates transverse zipper; FIG. 8H illustrates spring clips such as “alligator” clips; and FIG. 8I illustrates buckles;

FIG. 9 illustrates a perspective view of a person preparing a bed for the flexible warming pad by turning down the bed coverings on a first side of a bed;

FIG. 10 illustrates a perspective view of a person performing the step of placing a flexible warming pad over the desired first side position on a bed;

FIG. 11 illustrates a perspective view of a person performing the step of inserting a flexible warming pad between the bed coverings on a first side of a bed;

FIG. 12 illustrates a perspective view of a person performing the step of connecting the power supply cord to a flexible warming pad after it has been inserted into position on a first side of a bed;

FIG. 13 illustrates an enlarged perspective view of a person performing the step of activating the detachable timer or power control switch of a flexible warming pad after it has been inserted into position on a first side of a bed;

FIG. 14 illustrates a perspective view of a person performing the step of repositioning a flexible warming pad further downwards beneath the bed coverings after activating the power control switch; and

FIG. 15 illustrates a perspective view of a person performing the step of repositioning a flexible warming pad from a first side of a bed to a second side of a bed by sliding it from beneath the bed coverings.

### DETAILED DESCRIPTION

The present invention recognizes and addresses the disadvantages of prior art construction limitations, application limitations, mobility limitations, and storage difficulties.

Reference is made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

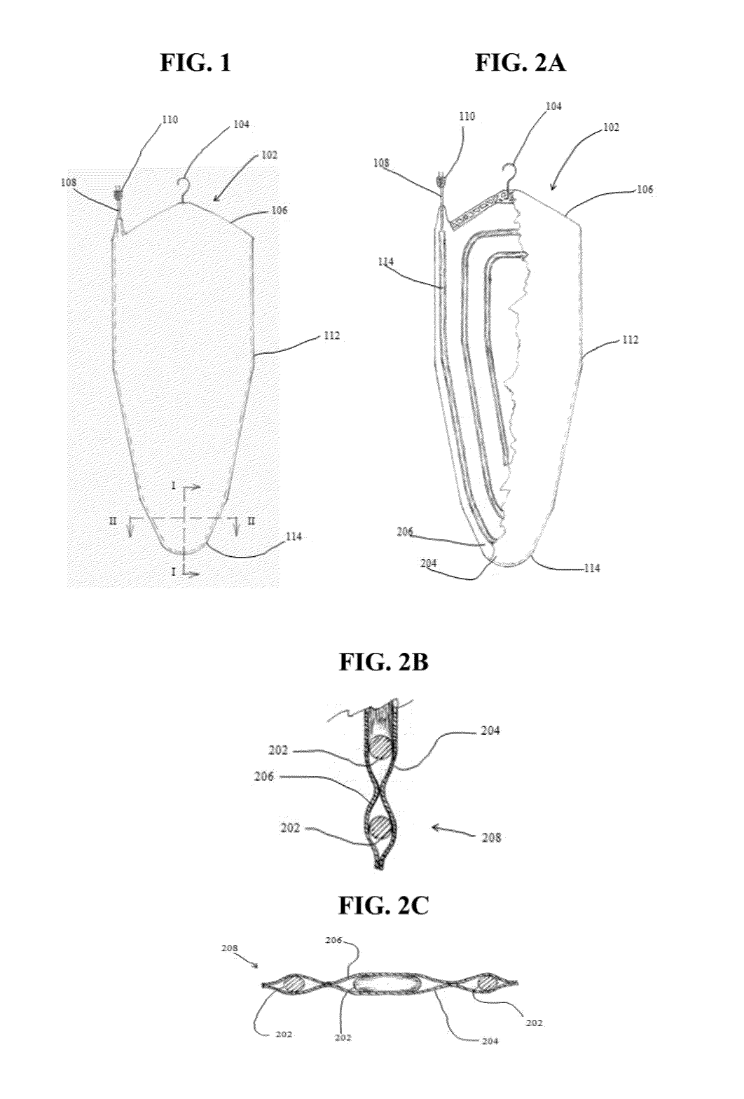

A flexible warming pad of the present invention is denoted by the number 102 as illustrated in FIG. 1 having a first end 106 and a second end 114 distal to the first end 106 and a hook 104 located proximal with respect to the first end 106 and adjacent to a power cord 108 and electrical connector 110. The flexible warming pad 102 is generally oblong shaped with the first end 106 transitioning into a wide intermediate portion 112, and a narrower second end 114.

Referring to FIGS. 2A-C, the internal construction of a preferred embodiment of the present invention flexible warming pad 102 is illustrated. The construction described herein includes a flexible resistive heating element 202 captured between top and bottom flexible polymeric enclosure sheets 204 and 206 respectively forming a polymeric enclosure 208. One method of making this construction is to secure the heating element 202 to the bottom sheet 206 of the polymeric enclosure 208 and then to apply and secure the top sheet 204 of the polymeric enclosure 208 via heat welding, cementing or sewing.

Generally, the flexible resistive heating element 202 includes a length of conductive material long enough to adequately traverse the active area of the warming pad 102, and through which an electrical current can be passed to produce heat. Many types of flexible resistive heating elements familiar to those skilled in the art can be implemented in the present invention. A few non-limiting examples of these exemplary heating elements include parallel resistance Positive Thermal Coefficient (PTC), characterized by having electrical resistance between parallel electrical conductors which increases enough with increasing temperature to allow self temperature limiting, carbon or metallic resistive wire or cord, and series connected or series parallel connected discrete resistive heating elements.

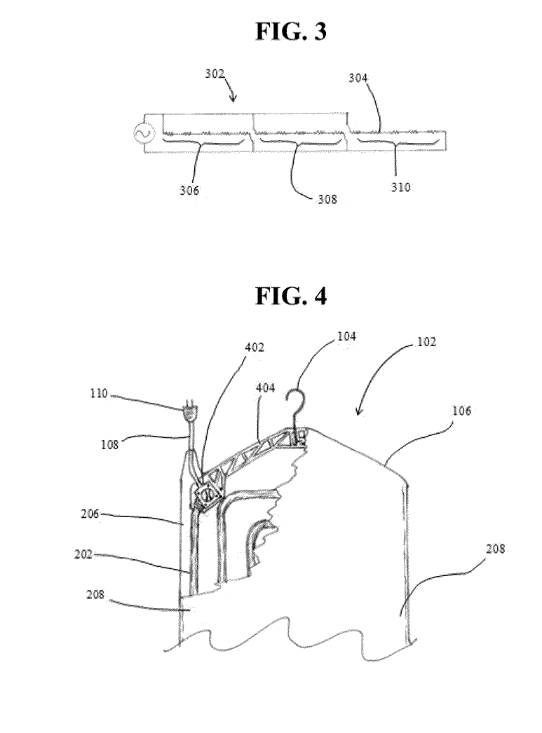

Referring now to the circuit diagram FIG. 3, a series parallel connected assembly 302 of resistive heating elements 304 is more reliable than a series connected assembly, since failure of one discrete heating element 304 will only cause failure of the first series string 306 to which it belongs, allowing the second and third remaining strings 308 and 310 respectively, of series parallel connected heating elements 304 to continue operating. A non-limiting example of a low cost discrete resistive heating element is an incandescent light bulb. Small, low power (generally 0.3 to 1 watts per bulb) incandescent light bulbs connected in series parallel assemblies have been used for many years for decorative lighting, but these assemblies are not particularly compact and pliable and are not well suited for use in a bed warming device deployed either above the bed occupant or below the occupant while the occupant is sleeping in the bed. One object of this invention is to incorporate the aforementioned assembly of incandescent bulbs as a flexible heating element 202 within the polymeric enclosure 208 of a flexible warming pad 102.

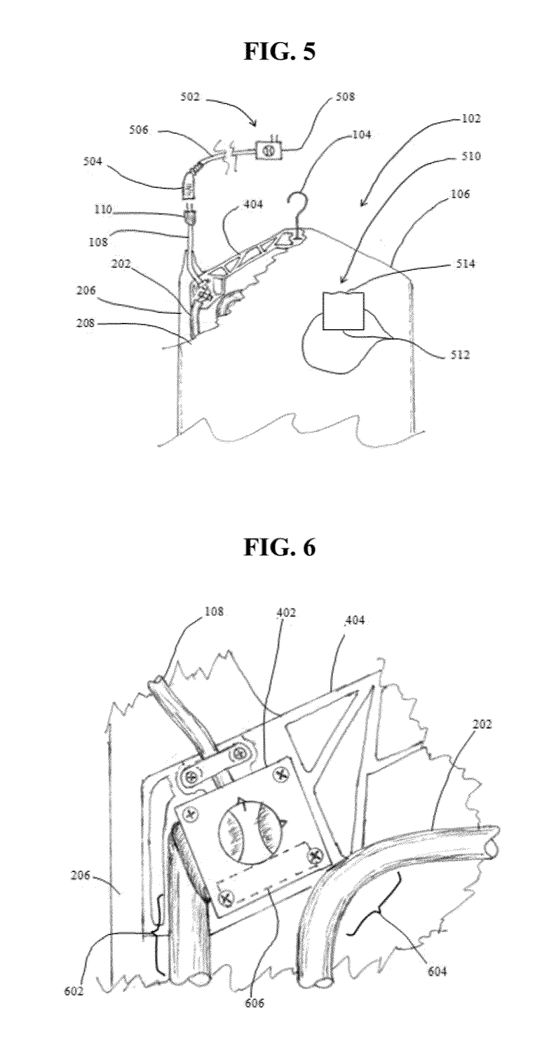

In reference to FIGS. 4 and 5, a flexible warming pad 102 used for preheating fabrics such as those used in the construction of heavy garments and bed coverings, is not intended to be placed in prolonged contact with human skin while energized, and can therefore be designed with different radiated electro-magnetic field limits, temperature limits and temperature controls than devices intended to be positioned close to a person's body or to contact a person's skin for extended time periods. It is an object of the present invention to incorporate a simple, detachable, timer-based power control system 502 that includes an electrical receptacle 504, a power cable 506, and a timer switch 402, to limit the maximum temperature of the flexible warming pad 102, as illustrated in FIG. 5. It is another object of this invention to incorporate one or more electrical thermostats (not shown) along the length of the heating element 202, in addition to or in place of, a detachable timer based power control system 502 as the temperature control system for a flexible warming pad 102. It is another object of this invention to include an actuator, e.g., an integral timer switch 402 proximally located with respect to the first end 106 of the flexible warming pad 102 as best shown in FIGS. 4 and 6. It is another object of this invention to incorporate into a flexible warming pad 102, one or more electrical thermostats (not shown) along the length of the heating element 202, in combination with or in place of, the integral timer switch 402 to limit the temperature of the flexible warming pad 102.

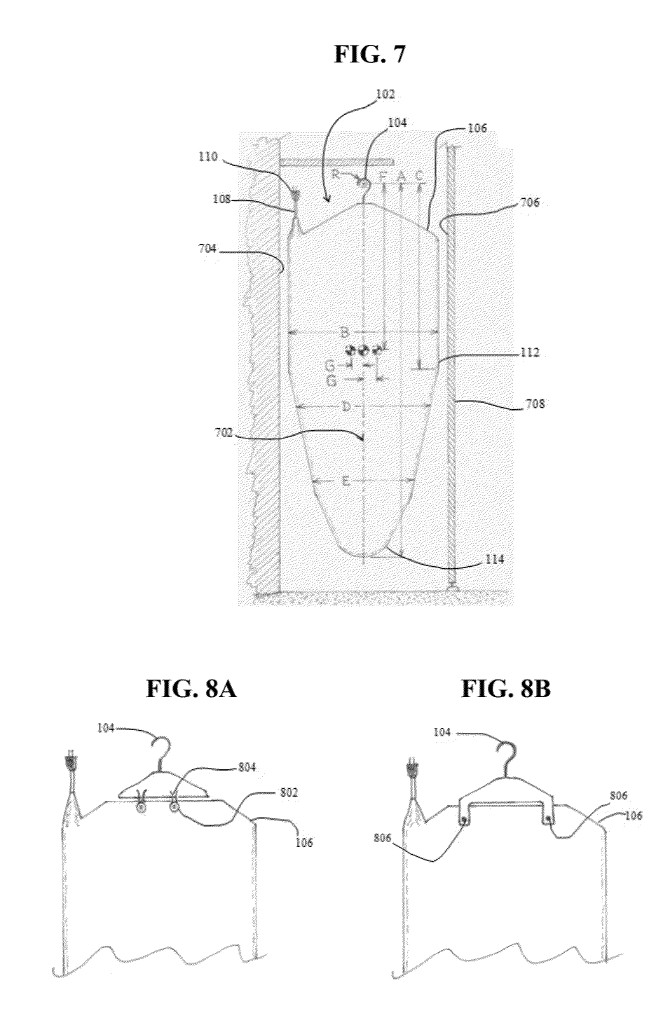

Referring now to FIG. 6, it is another object of this invention to incorporate one or more integrated electrical thermostats into the integral timer switch 402, where an individual thermostat or a plurality of thermostats can sense temperature from one or more portions of the heating element 202, exemplified in FIG. 6 as zones 602 and 604. The one or more integrated electrical thermostats optionally may be located proximally with respect to zones 602 and 604, in an area 606 illustrated with the dashed line rectangular box. With additional reference to FIG. 7, the preferred embodiment of the present invention contains a rigid frame structure 404 which serves as a mounting point for the hook 104, power cord 108, integral timer switch 402, and flexible heating element 202, as well as providing a solid load carrying support for the entire combined weight of a heavy coat or jacket and the flexible warming pad 102 when the flexible warming pad 102 is used for garment preheating. This rigid frame structure 404 could be constructed from injection molded resin, stamped or cast metal, or other suitable structural materials familiar to those skilled in the art.

In the typical use of the present invention, the user may want to pre-position the warmer into either the garment or the bed more than a few minutes in advance of the intended use of the article. An example of this would be in a multi-floor house or apartment where the user may pass by the garment or bed well in advance to its intended use time, and then move on to another floor or another distant room for some other activity prior to returning to the place where the article and warming pad are located. In order to avoid wasting time to make a dedicated trip to turn on the power to the warming pad, an actuator, e.g., a remote control switch (not shown), can be incorporated into the circuitry of the flexible warming pad 102. It is an object of this invention to incorporate a wireless remote control into the power circuit of a warming pad.

To efficiently accomplish the two fabric warming applications, specifically garment warming and bed warming, a flexible warming pad 102 may have a specific form and size. The preferred embodiment of the present invention is illustrated with characteristic dimensions in FIG. 7. In this embodiment, the flexible warming pad 102 has a geometrical form which fits inside of most jackets and long coats and supports them as a typical clothes hanger would do, while hanging from a rack, rail, or clothes hook. The geometrical form shown in FIG. 7 is also optimized for storage within standard clothes closets. In this embodiment, the values of the flexible warming pad 102 dimensions specified in FIG. 7 are as follows:

| Dimension | Measurement range |
|---|---|
| A | 40-60 inches |
| B | 20-24 inches |
| C | 30% to 70% of “A” |
| D | Less than B |
| E | Less than B |
| F | 30% to 50% of “A” |
| G | 0-3 inches |
| R | Accepts up to 2 inch dia. Rod |

The above dimensions not only provide a good fit within common adult sized garments and clothes storage closets, but also provide an area and form that works well when preheating a sleeping area for an averaged sized adult within a bed and its coverings.

The preferred embodiment of the present invention is constructed with a mechanism or system for hanging storage, in an example embodiment, the mechanism or system includes a hook 104. The hook 104 of the present invention is located proximally to the first end 106 of the flexible warming pad 102 as previously described, such that the center of the hook 104 is located within about 3 inches laterally of the geometric centerline 702 of the warming pad width (see FIG. 7, dimension G). The geometric centerline 702 in turn is located within about 3 inches of the center of gravity (depicted with a partially shaded circle) of the warming pad. In other words, the warming pad is constructed such that when it is hung vertically by the hook, the exterior profile of the pad falls within a +/−12 inch lateral boundary on either side of the vertical plane which is both coincident with the hook 104 center and perpendicular to the plane of the flexible warming pad 102 predominant surface. The aforementioned geometry prevents the edges of the flexible warming pad 102 from interfering with the back wall surface 704 or inside surface 706 of the door 708 of a typical clothes storage closet either when it is being stored or when it is being used to preheat a coat or jacket.

Referring in detail to FIG. 7, and table 1, the exterior profile of the flexible warming pad 102 of the present invention can be defined with the dimensions A-F. Dimensions A and B provide for a large heating surface suitable for both an adult's sleeping area within a bed, and for a complete coverage within the inside of most adult coats or jackets. The exterior profile of the flexible warming pad of the present invention has a generally tapered form. This tapered form originates at intermediate portion 112, which generally corresponds to the waist or beltline of an adult human body form (see dimension C) and progresses downward toward the second end 114 of the flexible warming pad 102, the tapered profile being described with dimensions D and E where both dimensions D and E are less than dimension B. The tapered form of the present invention also functions as a “lead-in” to smoothly separate the bed coverings with minimal friction resistance or snagging with the cloth as the device is inserted into position between layers of bed coverings.

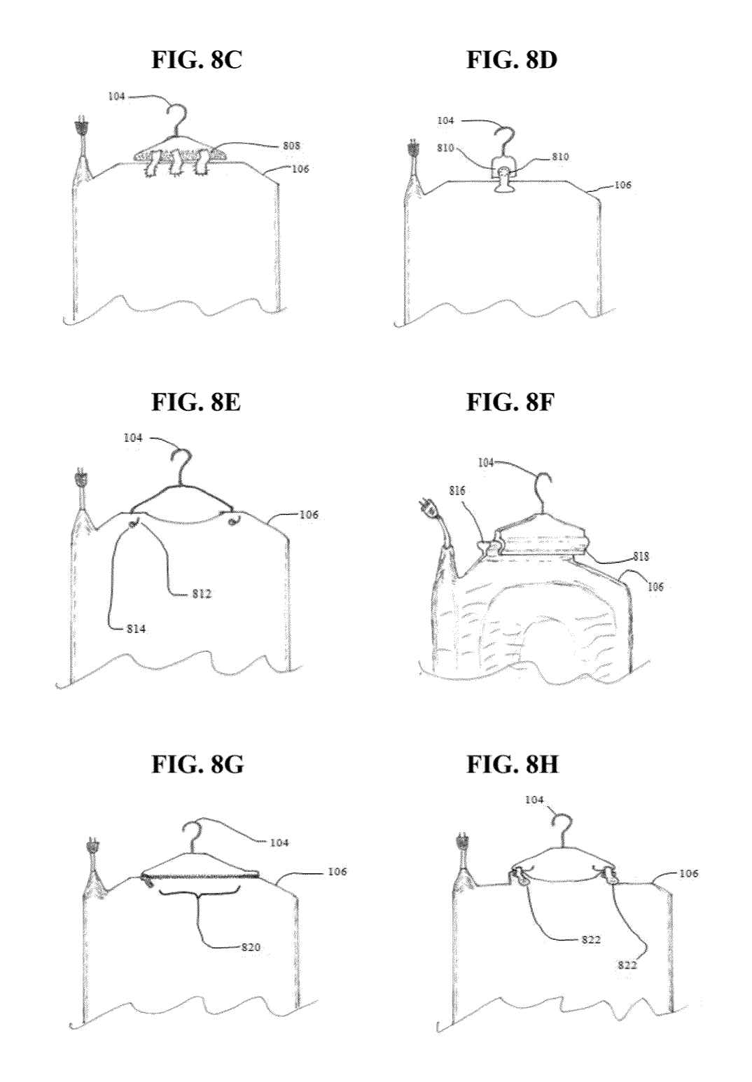

The preferred embodiment of the present invention is constructed with a storage hook 104 which is integral to the main body at the first end 106 of the flexible warming pad 102 as illustrated in FIG. 1. Other embodiments of the storage hook 104 connection with the present invention are illustrated in FIGS. 8A-I and include a separable hook with adequate system or mechanism for convenient and cost effective attachment to the first end 106 of the flexible warming pad 102. As best illustrated in FIGS. 8A-I, non-limiting examples of mechanisms for attachment of the hook 104 to the first end 106 of the flexible warming pad 102 include: FIG. 8A, which illustrates button 802 and loop 804 or button holes; FIG. 8B, which illustrates fabric snaps 806; FIG. 8C, which illustrates hook and loop flexible fastener 808; FIG. 8D, which illustrates magnet 810 to magnet 810 or magnet 810 to steel couplers; FIG. 8E, which illustrates attachment hooks 812 and mating holes 814; FIG. 8F, which illustrates male dovetail 816 and female dovetail 818; FIG. 8G, which illustrates transverse separable zipper 820; FIG. 8H, which illustrates spring clips 822 such as “alligator” clips; and finally FIG. 8I, which illustrates buckles 824. In some embodiments, a rigid grip portion may be disposed at an end of the flexible warming pad 102. A rigid grip portion may enable a user to easily move the flexible warming pad 102 from one position to another position. In an example embodiment, for example as illustrated in FIG. 8F, the male dovetail 816 may be the rigid grip portion.

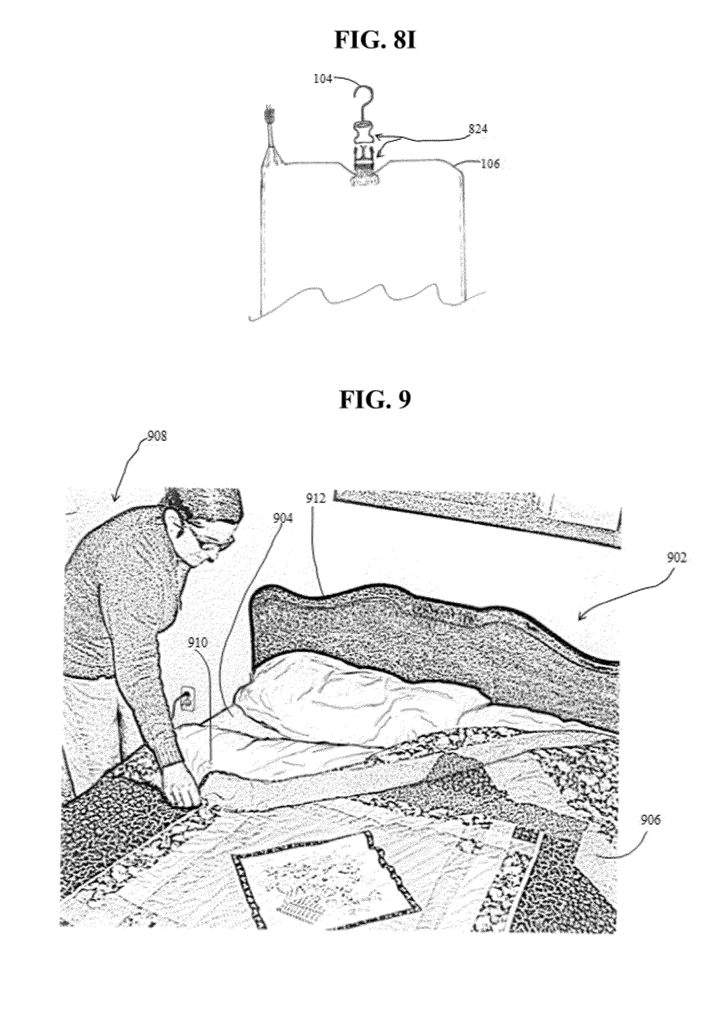

With reference to FIGS. 9-15, the preferred embodiment of the present invention is configured for easy and convenient insertion by the user 908 into the sleeping area of a typical bed 902 and also for easy transfer from a first side 904 of the bed 902 to a second side 906 of the bed 902 by the user 908. Referring in more detail to FIGS. 9-15, the method of use of the present invention for preheating of a typical bed 902 is illustrated.

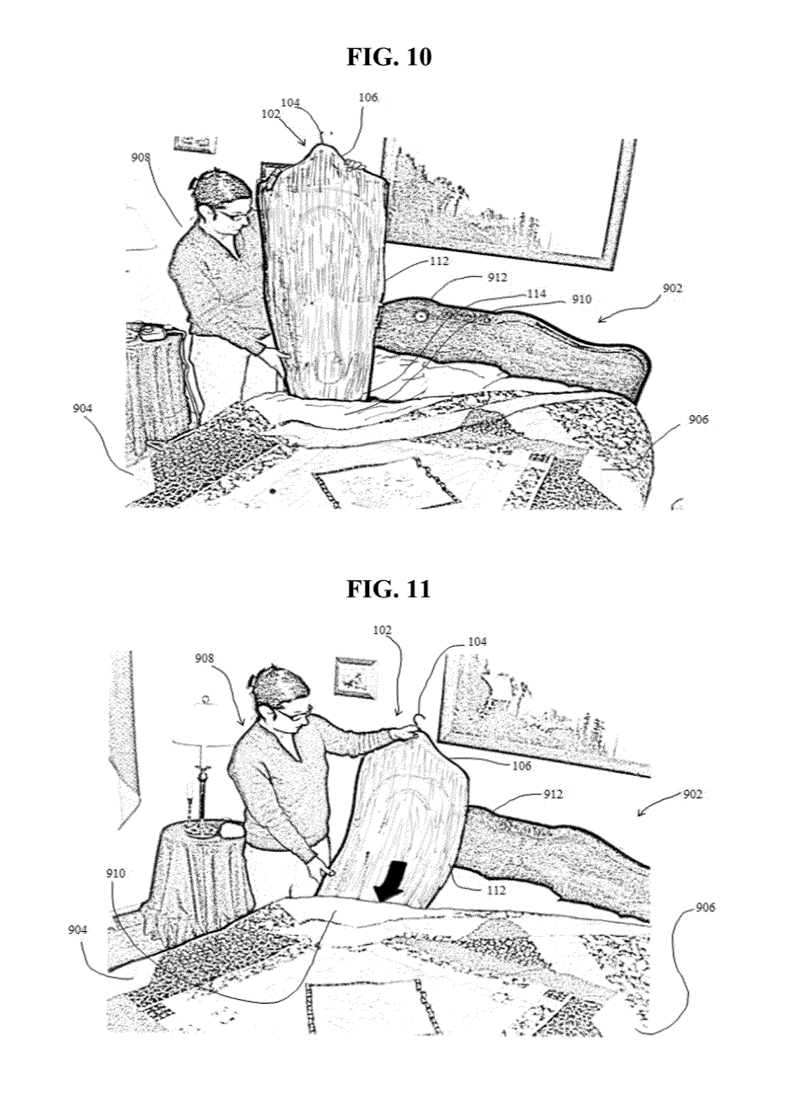

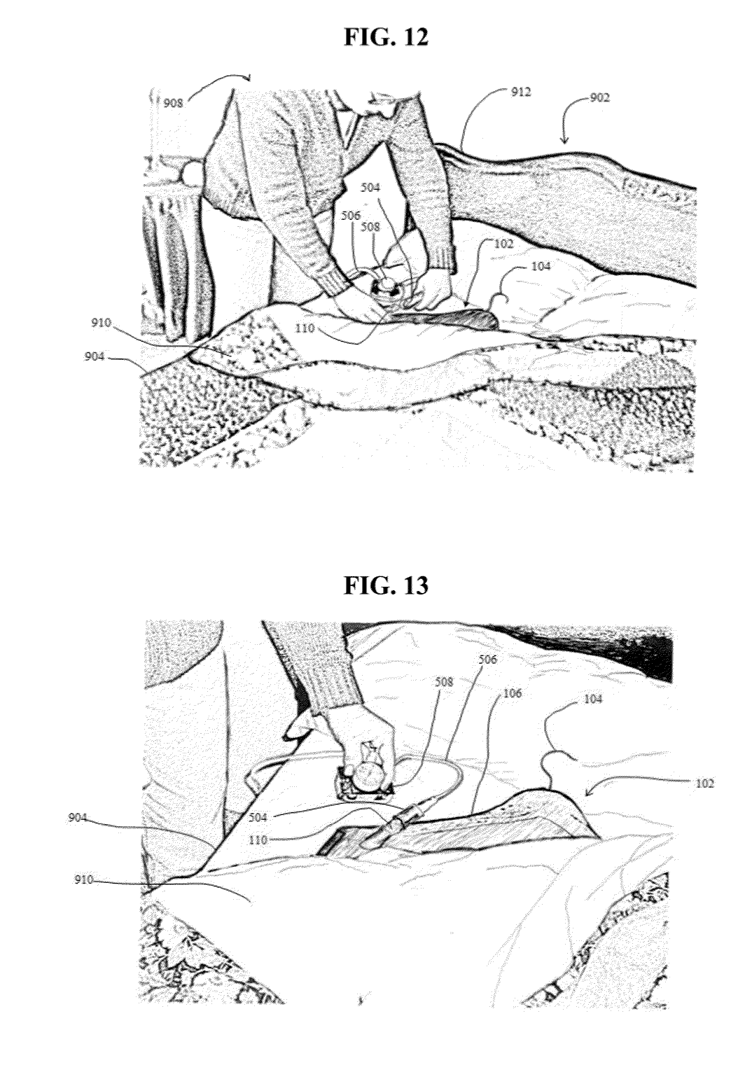

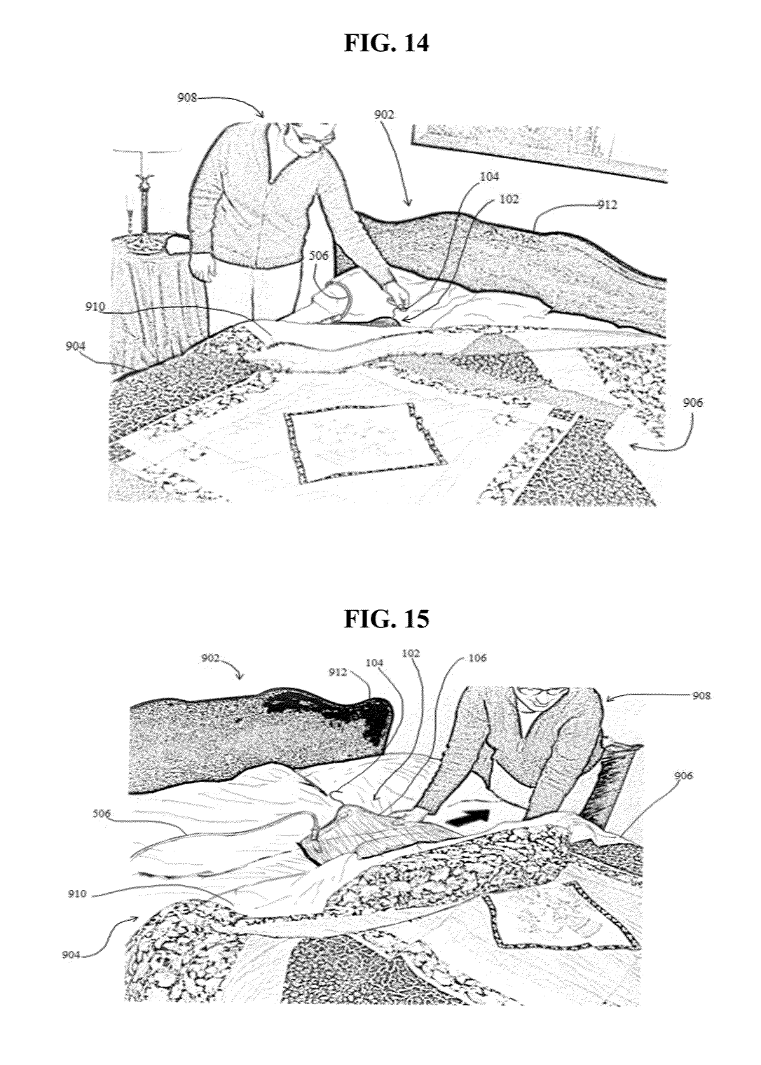

The preferred method of using the flexible warming pad 102 of the present invention in the bed warming application is as follows: 1) open or “turn down” the top layer of bed coverings 908—illustrated in FIG. 9; 2) position the flexible warming pad 102 vertically over the open bed coverings 908 with the hook 104 on the first end 106 away from the bed 902 illustrated in FIG. 10; 3) insert the bottommost second end 114 of the flexible warming pad 102 into the opening in the covers and allow the flexible warming pad 102 to bend slightly across its intermediate portion 112 as it is pushed in the direction of the large arrow into the space beneath the layer of bed coverings 910 illustrated in FIG. 11; 4) with the first end 106 and electrical connector 110 exposed, connect the flexible warming pad 102 to the power cable 506 via the electrical receptacle 504 illustrated in FIG. 12; 5) place the electric timer switch 508 into the “on” position illustrated in FIG. 13; and 6) push the flexible warming pad 102 into the final desired position beneath the bed coverings 910 illustrated in FIG. 14.

If there are two people using the bed 902 and it is desired to warm both sides of the bed 902, an advantage of the present invention is that it can easily be transferred from a first side 904 of the bed 902, over to a second side 906 of the bed 902 as illustrated in FIG. 15. This figure illustrates a user 908 taking the additional step of pulling the flexible warming pad 102 across the bed while the flexible warming pad 102 is still positioned under the bed coverings 910, by grasping it near the first end 106 and intermediate portion 112 and pulling. Once the flexible warming pad 102 is in place again on the second side 906 of the bed 902, the user 908 can energize the flexible warming pad 102 with the timer switch 508 as described previously in step 5 above and illustrated in FIG. 13. If the flexible warming pad 102 is transferred to the second side 906 of the bed 902 within several minutes of reaching its working temperature while positioned on the first side 904 of the bed 902, the residual heat in the flexible warming pad 102 will transfer to the bed coverings 910 of the second side 906, and reduce the amount of time and energy needed to reach a satisfactory temperature on the second side 906 of the bed 902. The flexible warming pad 102 of the present invention requires approximately 80 to 200 watts of energy in order to achieve a comforting temperature within the specified area of the bed coverings 910 within a convenient time period of about 8 to 25 minutes.

The temperature of the bed coverings 910 surrounding the flexible warming pad 102 will typically reach 120 to 160 degrees Fahrenheit at the end of the heating period; this temperature is typical of the temperature achieved in clothes dryers, and is also above the temperature needed to kill the common parasite referred to as a “bed bug.” Furthermore, 120 to 160 degrees Fahrenheit is above the typical bed covering temperature achieved through the use of traditional heated covers known as “electric blankets” or through the use of heated mattress pads both of which are designed for use while the bed occupant is in close proximity to the heating device for extended periods of time. It is a further object of this invention to provide a portable way for localized extermination of bed bugs though the application of elevated levels of heat to bed coverings. In order to prevent discomfort when a user casually contacts the flexible warming pad 102 with bare skin, and to prevent possible heat damage to garments or bed coverings, the actual surface temperature of the flexible polymeric enclosure 208 may be designed to not exceed about 170 degrees Fahrenheit. Transfer of the flexible warming pad 102 from one side of the bed to the other while it is still warn from use on the first side of the bed will cut the warming time for the second bed side down significantly—by as much as 50%. This heating time reduction equates to a power consumption reduction of 50%, or as much as 42 watt-hours per use or 292 watt-hours per weekly use compared with a stationary bed warmer with equal heating watts per square foot large enough to cover both sides of a bed designed for 2 occupants.

One embodiment of the present invention as illustrated in FIG. 5, incorporates an integral pouch 510 affixed to the main surface of the flexible warming pad 102 proximally located relative to the first end 106. This integral pouch 510 is constructed from a separate piece of thin planar material generally oblong in shape with an adjacent series of affixed edges 512, connected to the main surface of the flexible warming pad 102, and at least one open edge 514 not connected to the main surface of the flexible warming pad. The function of the integral pouch 510, which is configured similar to a typical shirt pocket is to temporarily capture a scented packet or card (not shown). The scented packet or card can optionally be inserted into the integral pouch 510 of the flexible warming pad 102 prior to use in order to propagate the scent into the garment or bed coverings 910 during the heating mode of the flexible warming pad 102. The heated surface of the flexible warming pad 102 will accelerate the diffusion of the scent from the scented packet or card so that the garment or bed coverings will have a pleasing aroma with only a short time exposure to the scented packet or card. The construction of the scented packet or card should be familiar to those skilled in the art, and would eventually lose its concentration of scent and would need to be replaced.

One embodiment of the present invention has an external surface friction coefficient, and flexural stiffness in the plane normal to its predominant surface and passing through the geometric centerline 702, which in combination preclude lateral buckling or “kinking” of the flexible warming pad 102 when it is being transferred from a first side 904 of the bed 902 to the second side 906 of the bed 902 (see FIG. 15). Additionally an embodiment of the invention is constructed such that its external surface friction coefficient combined with its column stiffness in the longitudinal axis coincident with the geometric centerline 702 precludes axial buckling of the flexible warming pad 102 when the flexible warming pad 102 is initially being slid lengthwise under the bed coverings 910 (see FIG. 11).

With continued reference to FIG. 11, since most beds 902 have a vertical obstruction such as a headboard 912 or a wall immediately behind the top of the bed 902, the flexible warming pad 102 of the present invention should be flexible in order to be conveniently slid between the bed coverings 910 of such a bed 902. If the structure of the removable bed warmer were rigid as are those removable bed warmers of the prior art, the user would be forced to remove or lift a larger portion of the bed coverings in order to insert the warmer. To maximize convenience and avoid the need to lift or remove the bed coverings 910 as the flexible warming pad 102 makes the transition from vertical orientation to horizontal orientation as it is being slid between the bed coverings 910, (see FIG. 12) the flexural stiffness in the plane parallel to its main surface should be sufficiently low as to allow it to easily achieve a bending radius of about 24″. This flexural stiffness at typical indoor temperatures of approximately 60 to 75 degrees Fahrenheit can be achieved with a Polyvinylchloride (PVC) construction for both the body of the flexible resistive heating element 202 and the top and bottom flexible polymeric enclosure sheets 204 and 206, where the total area moment of inertia in the intermediate portion 112 as measured in a section perpendicular to the geometric centerline is in the range of 0.014 to 0.028 in⁴. This area moment of inertia can be achieved with various proportions of enclosure sheet 204 and 206 thickness and flexible heating element 202 section size, as an example, the sheets could be 0.016″ thick, and the heating element could be 0.5″ in diameter. Alternatively, the polymeric enclosure sheets 204 and 206 could have a variable thickness with portions much greater than 0.016″ thick, and the heating element 202 could be smaller than 0.5″ in diameter such that a greater portion of the flexural stiffness is provided by the enclosure sheets 204 and 206 than the flexible heating element 202.

The flexible heating element 202 can be manufactured such that portions of the length are not electrically active, i.e. not capable of producing resistive heat; this will allow the inactive portions to be used purely as a stiffening structure to help achieve the necessary area moment of inertia for the flexible warming pad 102.

The following Table outlines features and corresponding numbers from the Figures:

Feature # Name of Feature
102 Flexible Warming Pad
104 Hook
106 First end of Flexible Warming
108 Power Cord
110 Electrical Connector
112 Intermediate Portion of Flexible
114 Second end of Flexible
202 Flexible Heating Element
204 Top Flexible Polymeric
206 Bottom Flexible Polymeric
208 Flexible Polymeric Enclosure
302 Series Parallel Connected
304 Heating Element
306 First Series String (of Heating
308 Second Series String (of
310 Third Series String (of Heating
402 Integral Timer Switch
404 Rigid Frame Structure
502 Timer Based Power Control
504 Electrical Receptacle
506 Power Cable
508 Electric Timer Switch
510 Integral Pouch
512 Affixed Edges
514 Open Edge
602 A Zone on the Flexible Heating
604 A second Zone on the Flexible
606 An Area inside the Integral
702 Geometric Centerline of
704 Back Wall Surface
706 Inside Surface
708 Door
802 Button
804 Loop
806 Fabric Snap
808 Hook & Loop fastener
810 Magnet
812 Attachment hook
814 hole
816 Male Dovetail
818 Female Dovetail
820 Transverse Separable Zipper
822 Spring clip
824 Buckle
902 Bed
904 First Side of Bed
906 Second Side of Bed
908 Bed User
910 Top Layer of Bed Coverings
912 Headboard

From the foregoing it will be seen that the flexible warming pad 102 of the present invention provides a convenient and simple way to provide bed pre-warming as well as heavy garment pre-warming on an as-needed basis. Various modifications may be made to the flexible warming pad 102 without departing from its scope, and are all contemplated to be within the teachings of the present invention. For example, it is within the scope of one of ordinary skill in the art to modify the thickness or composition of the polymeric cover 208, or to modify the size, length, and or construction of the flexible heating element 202.

It will be understood that certain features and subcombinations are of utility and may be employed without reference to other features and subcombinations. This is contemplated by and is within the scope of the present invention. It is also to be understood that all matter herein set forth or shown in the accompanying drawings is to be illustrative of applications of the principles of the invention and not in a limiting sense.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device comprising:
a flexible enclosure having a first end and a top surface;
a flexible heating element disposed within said enclosure; and
a hanging portion connected to said first end and operable to hang said flexible enclosure in a direction that is normal to said top surface.

2. The device of claim 1, further comprising a power source operable to provide power to said flexible heating element.

3. The device of claim 2, wherein said power source comprises a power cord and an electrical connector.

4. The device of claim 1, wherein said flexible enclosure comprises a first sheet and a second sheet.

5. The device of claim 4, wherein said first sheet and said second sheet comprise a polymeric material.

6. The device of claim 1, wherein said flexible heating element comprises a flexible resistive heating element.

7. The device of claim 1, wherein said flexible heating element comprises a series of resistive heating elements.

8. The device of claim 1, further comprising a timer switch operable to provide power to said flexible heating element based on a predetermined time.

9. The device of claim 1, further comprising a thermostat operable to detect a temperature of said flexible heating element.

10. The device of claim 1, wherein said hanging portion comprises a hook.

11. A device for use by a user, said device comprising:
a flexible enclosure having a first end and a top surface;
a flexible heating element disposed within said enclosure; and
a rigid grip portion connected to said first end and operable to be grasped by the user to move said flexible enclosure.

12. The device of claim 11, further comprising a power source operable to provide power to said flexible heating element.

13. The device of claim 12, wherein said power source comprises a power cord and an electrical connector.

14. The device of claim 11, wherein said flexible enclosure comprises a first sheet and a second sheet.

15. The device of claim 14, wherein said first sheet and said second sheet comprise a polymeric material.

16. The device of claim 11, wherein said flexible heating element comprises a flexible resistive heating element.

17. The device of claim 11, wherein said flexible heating element comprises a series of resistive heating elements.

18. The device of claim 11, further comprising a timer switch operable to provide power to said flexible heating element based on a predetermined time.

19. The device of claim 11, further comprising a thermostat operable to detect a temperature of said flexible heating element.

20. The device of claim 11, further comprising an actuator that is operable to turn on said heating element.
